(19) United States
(12) Patent Application Publication
(10) Pub. No.: US 2015/0332388 A1
(43) Pub. Date: Nov. 19, 2015

(54) RESERVE PRICE GUARANTEE

(71) Applicant: Renee Ziegenfus, Danville, CA (US)

(72) Inventor: Renee Ziegenfus, Danville, CA (US)

(21) Appl. No.: 14/588,133

(22) Filed: Dec. 31, 2014

Related U.S. Application Data
(60) Provisional application No. 61/994,770, filed on May 16, 2014.

(51) Int. Cl. G06Q 30/08

(52) U.S. Cl. CPC G06Q 30/08

(57) ABSTRACT

A method and system for preserving seller value with hidden reserve prices is presented. A computer system stores historical transaction data for a plurality of transactions and operates a networked commerce system. For an auction transaction on the networked commerce system, the networked commerce system determines a predicted minimum sale price for an associated product. The networked commerce system then detects a sale of the respective associated product in the respective auction transaction and determines an actual sale price for the sale of the respective associated product. If the actual sale price is less than the predicted minimum sale price for the respective associated product, the networked commerce system transfers value to a seller associated with the respective auction transaction.

### CLAIM OF PRIORITY

This application claims the benefit of priority to U.S. Provisional Patent Application Ser. No. 61/994,770, filed on May 16, 2014, which is incorporated by reference herein in its entirety.

### TECHNICAL FIELD

This application relates generally to the field of networked commerce systems and specifically to online auction systems.

### BACKGROUND

The rise of the computer age has resulted in increased access to personalized services online. As the cost of electronics and networking services drops, many services that were previously provided in person are now provided remotely over the Internet. For example, entertainment has increasingly moved online, with companies such as Netflix and Amazon streaming TV shows and movies to members at home. Similarly, electronic mail (e-mail) has reduced the need for letters to physically be delivered. Instead, messages are sent over networked systems almost instantly. Similarly, many commercial transactions can now be completed over computer networks.

For example, networked commerce systems allow users to purchase goods and services online. Without much of the overhead cost involved in stocking and staffing physical stores, networked commerce systems can offer reduced costs and wider selection of products. In addition, networked commerce systems can offer a variety of commercial transaction types, including but not limited to sales and auctions.

Auctions on networked commerce systems typically fall into two categories: auctions that include reserve prices and auctions that do not include reserve prices. A reserve price is set by the seller of a product so that if the bidding price of the product does not reach t the predetermined reserve price, the product is not sold and no money or goods are exchanged. Auctions without a reserve price result in a sale regardless of what bid price is ultimately reached. Sellers typically prefer reserve price auctions to ensure that their product is not sold too far beneath its fair market value. Prospective buyers generally prefer auctions without a reserve price to ensure that the product will actually be sold regardless of the final price.

### BRIEF DESCRIPTION OF THE DRAWINGS

The present description is illustrated by way of example, and not by way of limitation, in the Figures of the accompanying drawings.

FIG. 1 is a network diagram depicting a client-server system, within which one example embodiment may be deployed.

FIG. 2 is a block diagram illustrating a client system, in accordance with some embodiments.

FIG. 3 is a block diagram illustrating a networked commerce system, in accordance with some embodiments.

FIG. 4 is a block diagram of an exemplary data structure for a current listing database for storing transaction records, in accordance with some embodiments.

FIG. 5 is a flow diagram illustrating a process for preserving seller value through hidden reserve prices, in accordance with some embodiments.

FIG. 6 is a flow diagram illustrating a process for preserving seller value through hidden reserve prices, in accordance with some embodiments.

FIG. 7 is a block diagram illustrating a mobile device, according to an example embodiment.

FIG. 8 is a block diagram illustrating an architecture of software which may be installed on one or more devices, in accordance with some implementations.

FIG. 9 is a block diagram illustrating components of a machine, according to some example embodiments.

Like reference numerals refer to corresponding parts throughout the drawings.

### DETAILED DESCRIPTION

Although embodiments are described with reference to specific example embodiments, it will be evident that various modifications and changes may be made to these embodiments without departing from the broader spirit and scope of the description. Accordingly, the specification and drawings are to be regarded in an illustrative rather than a restrictive sense.

In various embodiments, methods and systems for preserving seller value through hidden reserve prices are described. A networked commerce system stores (or has access to) a large amount of past historical transaction data. Using this data, the networked commerce system can determine a predicted sale price for a given product based on the historical sales data for that product or similar products.

The networked commerce system can then establish a guaranteed base price for the product. The guaranteed base price is based on the predicted sale price. In some embodiments the guaranteed base price and the predicted sale price are the same. In other embodiments the guaranteed base price is some established fraction of the predicted sale price (e.g., 90% of the predicted sale price). The networked commerce system can then use this guaranteed base price to establish a hidden reserve price guarantee for the product.

A hidden reserve price guarantee is a guarantee that it the product sells for a price below the guaranteed base price the networked commerce system itself will transfer money to the seller to at least partially make up the difference. For example, if the guaranteed base price is $100 and the product sells for $90, the networked commerce system sends the seller $10 to make up the difference.

The hidden reserve price guarantee is beneficial to all involved parties. First, the seller is reassured that their risk of a lower than expected sales price is reduced. Second, buyers who prefer non-reserve auctions can be involved in the auction because either they do not know that there is a hidden reserve price guarantee or (if the system reveals which products have a hidden reserve price guarantee) they know that the product will be sold regardless of the final sales price. Third, the networked commerce system benefits because more products will be listed for auction through the networked commerce system (because of increased seller confidence) and more sellers will bid on products with a hidden reserve price guarantee (thus increasing the final bid price on average).

Once a product with a hidden reserve price guarantee is sold (e.g., the auction ends and a final bid price is established), the networked commerce system determines whether the final bid price is more or less than the guaranteed base price. If the final bid price is more than the guaranteed base price, the networked commerce system processes the sale normally.

However, if the final bid price is less than the guaranteed base price, the networked commerce system transfers an amount of money to the seller of the product. In some embodiments the networked commerce system transfers the full difference between the final bid price and the guaranteed base price. As seen in the example above, if the guaranteed base price is $100 and the product sells for $90, the networked commerce system sends the seller $10 to make up the difference. in other embodiments the networked commerce system transfers a percentage of the difference in price (e.g., 90% of the difference).

In some embodiments the networked commerce system automatically purchases an insurance product from a third party to defray the risks involved in providing a hidden reserve price guarantee. In this way the networked commerce system is able to control the risk of multiple final bids coming in significantly under the guaranteed base price.

Once transactions with a hidden reserve price guarantee are finalized, the transaction details are stored and used in future estimations of guaranteed base price. In some embodiments, hidden reserve price guarantees are available for all auctions that occur on the networked commerce system. In other embodiments, hidden reserve price guarantees are available only for certain auctions, based on the product type, the country of origin of the seller, the estimated sale price of the product, or any other relevant factor.

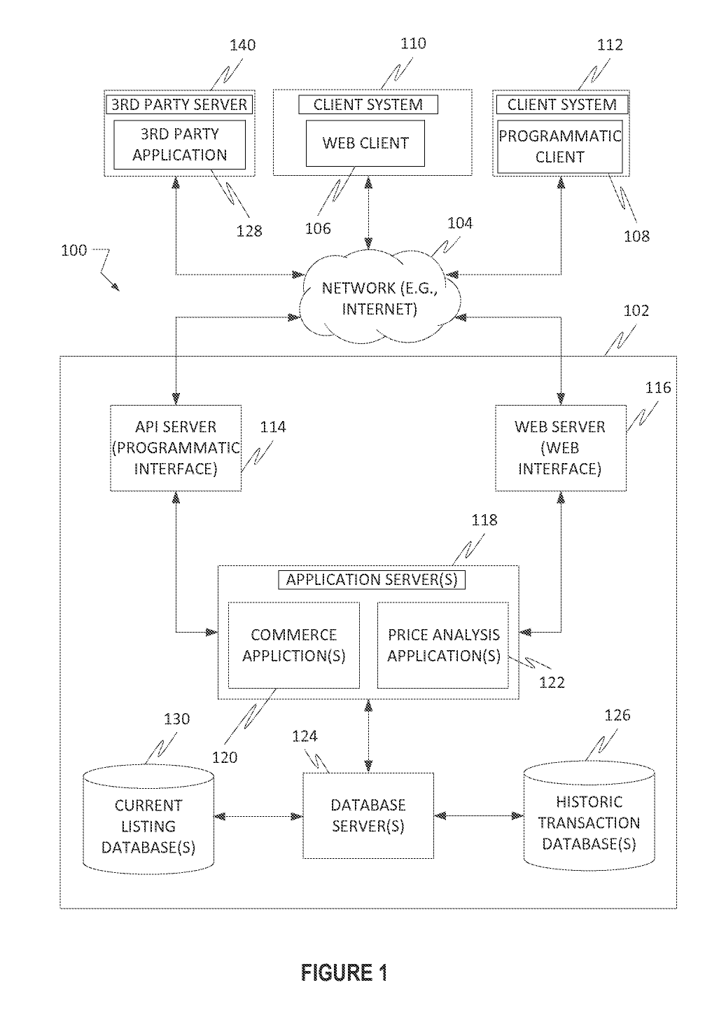

FIG. 1 is a network diagram depicting a client-server system 100, within which one example embodiment may be deployed. A networked commerce system 102, in the example forms of a network-based marketplace or publication system, provides server-side functionality, via a network 104 (e.g., the Internet or a wide area network (WAN)), to one or more clients. FIG. 1 illustrates, for example, a web client 106 (e.g., a browser, such as the Internet Explorer® browser developed by Microsoft® Corporation of Redmond, Wash. State) and a programmatic client 108 executing on respective client systems 110 and 112.

An Application Program Interface (API) server 114 and a web server 116 are coupled to, and provide programmatic and web interfaces respectively to, one or more application servers 118. The application servers 118 host one or more commerce applications 120 and price analysis applications 122. The application servers 118 are, in turn, shown to be coupled to one or more database servers 124 that facilitate access to one or more historic transaction databases 126 and current listing databases 130.

The commerce applications 120 provide a number of commerce functions, including but not limited to buying and selling products, auctions, payment processing, reviews, product and user ratings, and any other capabilities needed to effectively run a networked commerce system.

The price analysis applications 122 analyze data stored in the historic transaction database 126 to generate information that the price analysis applications 122 use to determine estimated sale prices for products. Thus, when a new product is listed with the networked commerce system 102, the price analysis applications 122 determine whether transaction data for any similar product has been received and catalogued. If so, the price analysis applications 122 then determine a predicted sale price for the product. The comparison and prediction can be made using various factors including, but not limited to, the type of product, product fair market value, date and time of auction, country of origin, product brand, time elapsed since the transaction was completed, and buy it now price (e.g., a price, for a listed auction transaction, that the seller is willing to take to immediately end the auction and sell at).

While the commerce and price analysis applications 120 and 122 are both shown in FIG. 1 to form part of the networked commerce system 102, it will be appreciated that other configurations can be used such that the commerce applications 120 and the price analysis applications 122 may each form part of a service that is separate and distinct from the networked commerce system 102.

Further, while the system 100 shown in FIG. 1 employs a client-server architecture, the embodiments are, of course, not limited to such an architecture, and could equally well find application in a distributed, or peer-to-peer, architecture system, for example. The various commerce and price analysis applications 120 and 122 could also be implemented as standalone software programs, which do not necessarily have networking capabilities.

The web client 106 accesses the various commerce and price analysis applications 120 and 122 via the web interface supported by the web server 116. Similarly, the programmatic client 108 accesses the various services and functions provided by the commerce and price analysis applications 120 and 122 via the programmatic interface provided by the API server 114. The programmatic client 108 may, for example, be a seller application (e.g., the Turbo Lister application developed by eBay Inc., of San Jose, Calif.) to enable sellers to author and manage listings on the networked commerce system 102 in an offline manner, and to perform batch-mode communications between the programmatic client 108 and the networked commerce system 102.

FIG. 1 also illustrates a third party application 128, executing on a third party server 140, as having programmatic access to the networked commerce system 102 via the programmatic interface provided by the API server 114. For example, the third party application 128 may, utilizing information retrieved from the networked commerce system 102, support one or more features or functions on a website hosted by a third party. The third party website may, for example, provide one or more promotional, marketplace, or payment functions that are supported by the relevant applications of the networked commerce system 102.

The commerce and price analysis applications 120 and 122 may be hosted on dedicated or shared server machines (not shown) that are communicatively coupled to enable communications between the server machines. The commerce and price analysis applications 120 and 122 themselves are communicatively coupled (e.g., via appropriate interfaces) to each other and to various data sources, so as to allow information to be passed between the applications 120 and 122 or so as to allow the applications 120 and 122 to share and access common data. The applications 120 and 122 may furthermore access the one or more historic transaction databases 126 and current listing databases 130 via the database servers 124.

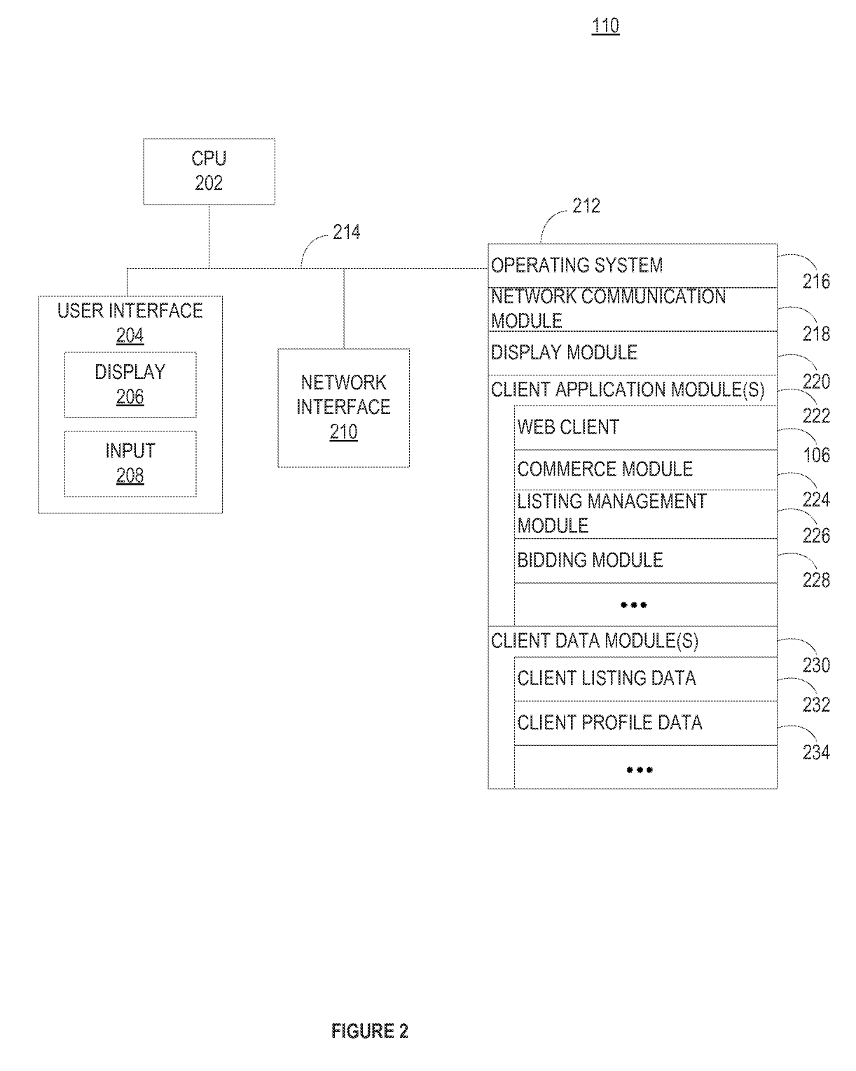

FIG. 2 is a block diagram illustrating a client system 110 in accordance with some embodiments. The client system 110 typically includes one or more processing units (CPUs) 202, one or more network interfaces 210, memory 212, user interface 204, and one or more communication buses 214 for interconnecting these components. The user interface 204 includes a display device 206 and optionally includes an input device 208 such as a keyboard, mouse, touch sensitive display, or other input device 208. Furthermore, some client systems use a microphone and voice recognition to supplement or replace the keyboard or other input devices.

The memory 212 includes high-speed random access memory, such as DRAM, SRAM, DDR RAM, or other random access solid state memory devices, and may include non-volatile memory, such as one or more magnetic disk storage devices, optical disk storage devices, flash memory devices, or other non-volatile solid state storage devices. The memory 212 may optionally include one or more storage devices remotely located from the CPU(s) 202. The memory 212, or alternately the non-volatile memory device(s) within the memory 212, comprises a non-transitory computer readable storage medium.

In some embodiments, the memory 212 or the computer readable storage medium of the memory 212 stores the following programs, modules, and data structures, or a subset thereof:
an operating system 216 that includes procedures for handling various basic system services and for performing hardware dependent tasks;
a network communication module 218 that is used for connecting the client system 110 to other computers via the one or more network interfaces 210 (wired or wireless) and one or more communication networks (e.g., network 104 of FIG. 1), such as the Internet, other WANs, local area networks (LANs), metropolitan area networks (MANs), etc.;
a display module 220 for enabling the information generated by the operating system 216 and client applications 222 to be presented visually on the display device 206;
one or more client applications 222 fir handling various aspects of interacting with the networked commerce system 102 of FIG. 1, including but not limited to:
   a web client 106 for requesting information from the networked commerce system 102 (e.g., product pages and user information) and receiving the response from the networked commerce system 102;
   commerce module 224 for making payments to the networked commerce system 102 to purchase goods and/or services;
   a listing management module 226 for allowing a user to make, edit, monitor, and delete auction listings for products on the networked commerce system 102; and
   a bidding module 228 for receiving and displaying bids from a user, transmitting the bids to the networked commerce system 102, and receiving an updated bidding list from the networked commerce system 102; and
a client data module 230 for storing data relevant to clients, including but not limited to:
   client listing data 232 that includes data about one or more listings on the networked commerce system 102 that are associated with the user of the client systems 110 and 112; and
   client profile data 234 that includes data about the user associated with the client system 110.

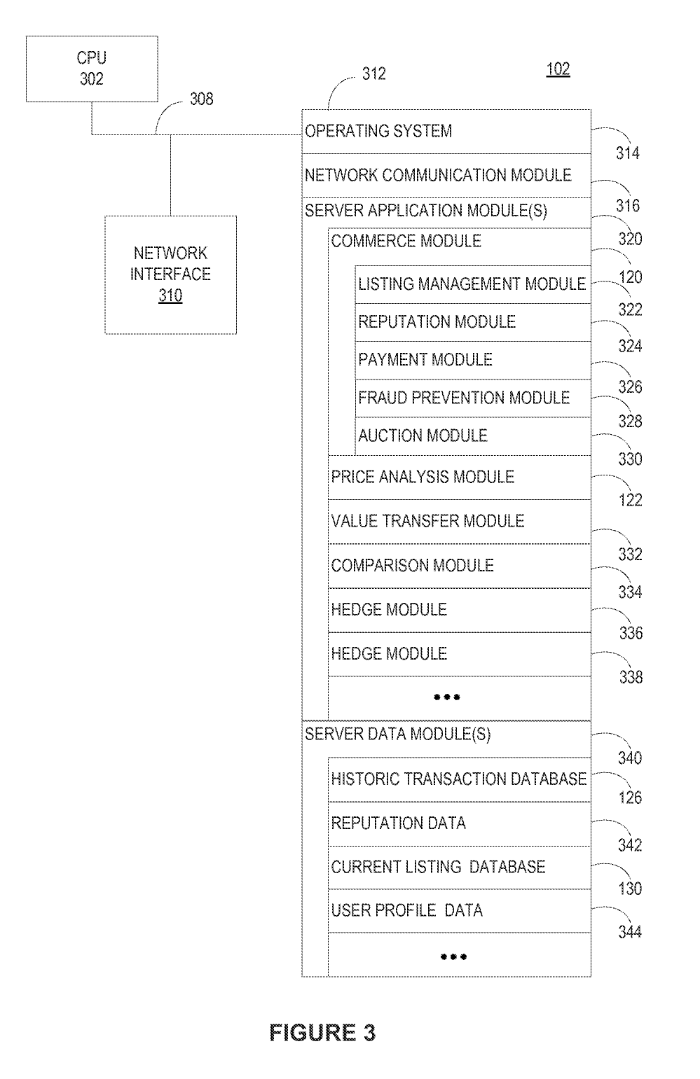

FIG. 3 is a block diagram illus rating a networked commerce system 102. The networked commerce system 102 typically includes one or more CPUs 302, one or more network interfaces 310, memory 312, and one or more communication buses 308 for interconnecting these components. The memory 312 includes high-speed random access memory, such as DRAM, SRAM, DDR RAM, or other random access solid state memory devices, and may include non-volatile memory, such as one or more magnetic disk storage devices, optical disk storage devices, flash memory devices, or other non-volatile solid state storage devices. The memory 312 may optionally include one or more storage devices remotely located from the CPU(s) 302.

The memory 312, or alternately the non-volatile memory device(s) within the memory 312, comprises a non-transitory computer readable storage medium. In some embodiments, the memory 312 or the computer readable storage medium of the memory 312 stores the following programs, modules, and data structures, or a subset thereof:
an operating system 314 that includes procedures for handling various basic system services and for performing hardware dependent tasks;
a network communication module 316 that is used for connecting the networked commerce system 102 to other computers via the one or more network interfaces 310 (wired or wireless) and one or more communication networks, such as the Internet, other WANs, LANs, MANs, and so on;
one or more server application modules 320 for performing the services offered by the networked commerce system 102, including but not limited to:
   a commerce module 120 for providing commerce services for the networked commerce system 102, including but not limited to:
      a listing management module 322 for allowing a user to make, edit, monitor, and delete auction listings for products on the networked con coerce system 102;
      a reputation module 324 for allowing users who transact utilizing the networked commerce system 102 to establish, build, and maintain reputations, which may be made available and published to potential trading partners;
      a payment module 326 for receiving and processing payments from users of the networked commerce system 102;
      a fraud prevention module 328 for implementing fraud detection and prevention mechanisms to reduce the occurrence of fraud within the networked commerce system 102; and
      an auction module 330 for enabling users to sell products using an auction format through the networked commerce system 102;
   a price analysis module 122 for determining a predicted sale price for a product based on information about the product and historical transaction data stored in the historic transaction database 126, by identifying the sales of similar products in the past;
   a value transfer module 332 for transferring value to a seller on the networked commerce system 102 when the actual sale price of a product is less than the guaranteed base price;
   a comparison module 334 for comparing the actual sale price against the guaranteed base price on which the hidden reserve price guarantee is based;
   a hedge module 336 for automatically hedging against the risk introduced by the hidden reserve price guarantee by purchasing appropriate insurance for each guarantee; and
   a hedge module 338 for determining a minimum price guarantee value for a particular product based on past sales information; and
networked commerce system data modules 340, holding data related to the networked commerce system 102, including but not limited to:
   a historic transaction database 126 including data about past commercial transactions, including, but not limited to, user data about the buyer, user data about the seller, user data about both the buyer and the seller, bid information, final price data, product descriptions, data information, and any other relevant data;
   reputation data 342 for users who are registered with the networked commerce system 102 that represents some or all of the data accumulated by the networked commerce system 102 that reflects user feedback for each user the networked commerce system 102;
   a current listing database 130 including data about all current listings in the networked commerce system 102; and
   user profile data 344, including data concerning user demographic information, user interests, products for sale, previous purchases, user location (e.g., based on global positioning system (GPS) data), and any other relevant user data.

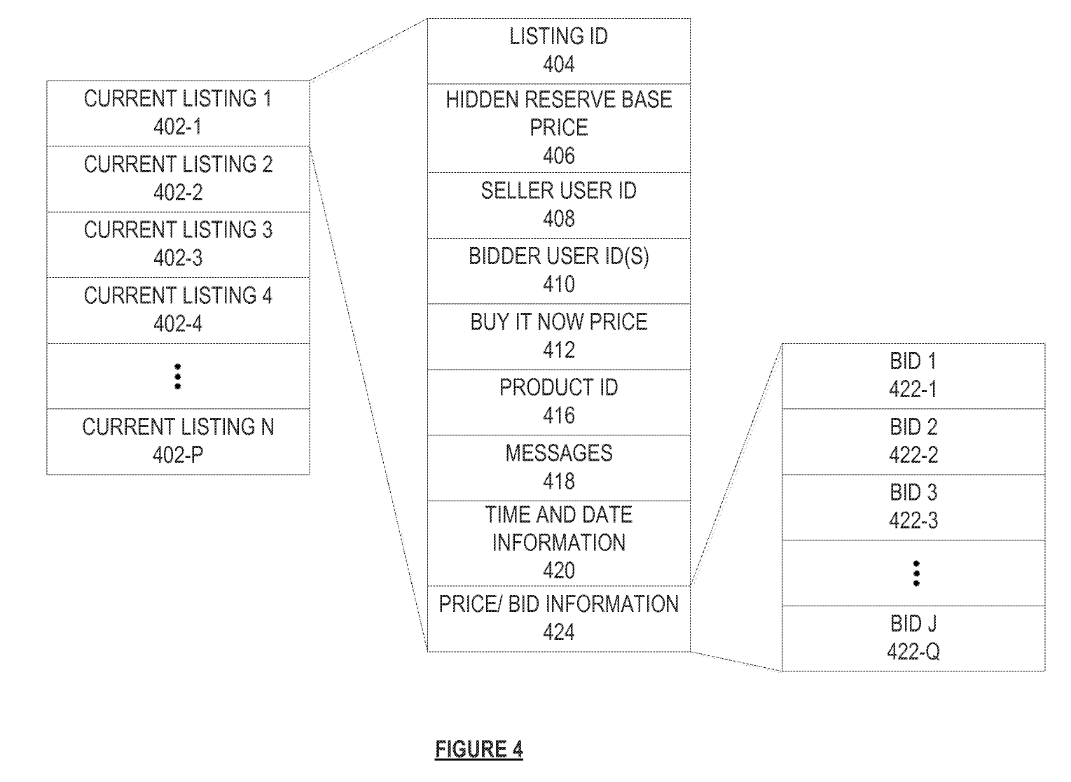

FIG. 4 is a block diagram of an exemplary data structure for a current listing database (e.g., database 130 in FIG. 1) for storing transaction records in accordance with some embodiments. In accordance with some embodiments, the current listing database 130 data structure includes a plurality of current listing records 402-1 to 402-P, each of which corresponds to a particular current product listing on a networked commerce system (e.g., the networked commerce system 102 in FIG. 1). For example, when a user (e.g., seller) wants to sell a product through the networked commerce system (e.g., the networked commerce system 102 of FIG. 1), the networked commerce system creates a listing that includes information about the product. Each current listing record 402-1 to 402-P stores the relevant information for the respective listing.

In some embodiments, a respective current listing record 402 stores a unique listing ID 404 for the transaction, a hidden reserve base price 406 (e.g., the price guaranteed by the networked commerce system), a seller user ID 408, a list of bidder user IDs 410, a buy it now price 412, a product ID 416, a list of one or more messages 418, time and date information 420, and price and bid information 424.

In some embodiments, the hidden reserve base price 406 is a dollar amount determined by the networked commerce system (e.g., the networked commerce system 102 in FIG. 1). This price is the price guaranteed by the networked commerce system (e.g., the networked commerce system 102 in FIG. 1), and if the product ultimately fails to sell for at least that amount, the networked commerce system (e.g., the networked commerce system 102 in FIG. 1) will return some or all of the difference to the seller.

The seller user ID 408 is a unique value associated with the seller consistently throughout the entire networked commerce system (e.g., the networked commerce system 102 in FIG. 1). The list of bidder user ID(s) 410 includes a list of unique user identifiers associated with users who have bid on the product.

The buy it now price 412. is a price that a potential buyer can pay to end the auction immediately and receive the product. This number is likely higher than the hidden reserve base price 406. In some embodiments, the product ID 416 is a unique value assigned by the networked commerce system 102 to a unique product.

In some embodiments, a current listing record 402 includes the list of messages 418 associated with the transaction. In some embodiments, there are no messages 418 in the list of messages 418. In other embodiments, the list of messages 418 has one or more messages 418. Each message record includes, but is not limited to, a listing of the sender, the recipient, the text of the message, and the time the message was sent.

In some embodiments, a current listing record 402 includes the time and date information 420 associated with the listing, including, but not limited to, a time when the current listing record 402 was created, times associated with any bids submitted by users, and an ending time at which the product associated with the product ID 416 will no longer be available. In some embodiments, a current listing record 402 includes the price and bid information 424. The price and bid information 424 includes, but is not limited to, the current price of the product associated with the product ID 416 and a list of bids 422-1 to 422-Q previously submitted for the product associated with the product ID 416.

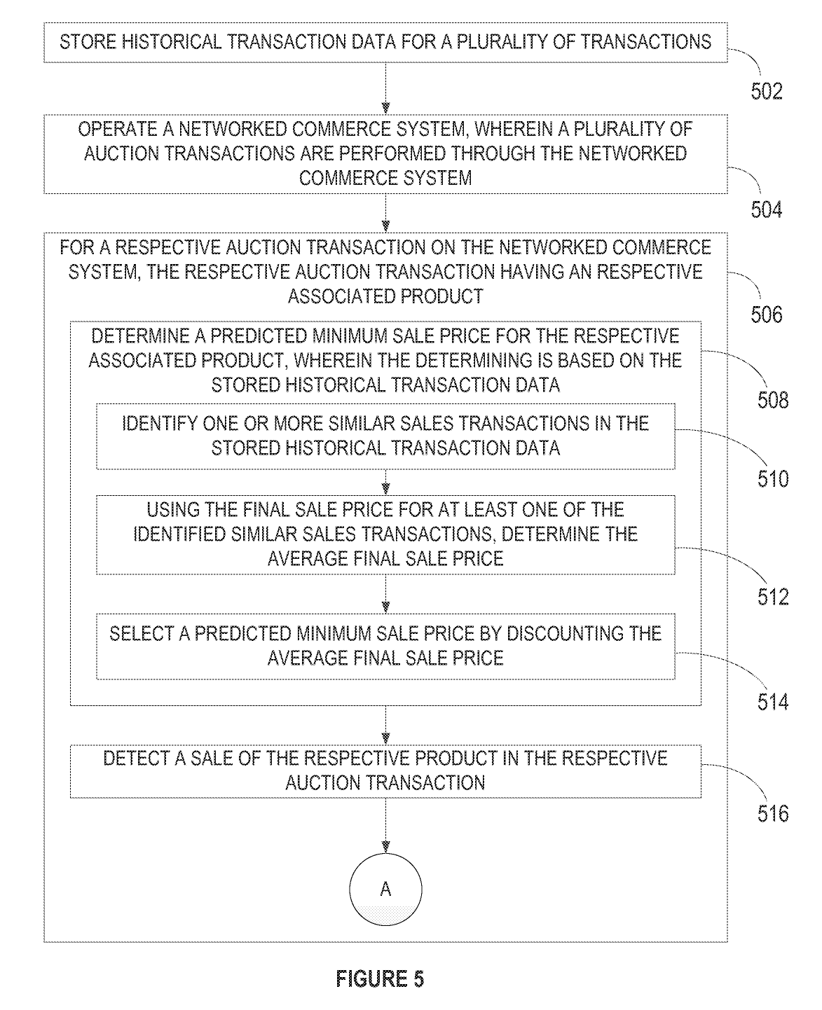

FIG. 5 is a flow diagram illustrating a process for preserving seller value through hidden reserve prices, in accordance with some embodiments. Each of the operations shown in FIG. 5 may correspond to instructions stored in a computer memory or computer readable storage medium. Optional operations are indicated by dashed lines (e.g., boxes with dashed-line borders). in some embodiments, the method described in FIG. 5 is performed by a server system (e.g., the networked commerce system 102 on FIG. 1).

In some embodiments, the method is performed by a server system including one or more processors and memory storing one or more programs for execution by the one or more processors.

In some example embodiments, a networked commerce system (e.g., the networked commerce system 102 in FIG. 1) stores (502) historical transaction data for a plurality of transactions. For example, the networked commerce system (e.g., the networked commerce system 102 in FIG. 1) stores all previous commercial transactions that have occurred through the networked commerce system (e.g., the networked commerce system 102 in FIG. 1). Each transaction also includes additional metadata about the transaction, including but not limited to the date of the transaction, the product type, the buyer and the seller, the final price, the initial price, and any other useful information.

The networked commerce system (e.g., the networked commerce system 102 in FIG. 1) operates (504) a networked commerce system, wherein a plurality of auction transactions are performed through the networked commerce system. The networked commerce system allows buyers and sellers of goods and services to find each other and arrange details of commercial interactions. This can occur through a website that allows goods and services to be posted and searched through by potential buyers.

For a respective auction transaction on the networked commerce system, wherein the respective auction transaction having (506) a respective associated product, the networked commerce system (e.g., the networked commerce system 102 in FIG. 1) determines (508), with one or more processors in the networked commerce system, a predicted minimum sale price for the respective associated product, wherein the determining is based on the stored historical transaction data. For example, for a coin with an estimated true value of $500, the predicted minimum sale price is set at $350.

When determining the predicted minimum sale price, the networked commerce system (e.g., the networked commerce system 102 in FIG. 1) identifies (510) one or more similar sales transactions in the stored historical transaction data. Using the final sale price for at least one of the identified similar sales transactions, the networked commerce system (e.g., the networked commerce system 102 in FIG. 1) determines 512) an average final sale price.

In some example embodiments, the networked commerce system (e.g., networked commerce system 102 in FIG. 1) conducts an actuarial analysis of expected payments for determining the frequency and severity of the scenarios based on stored information where the actual sale price is less than the predicted minimum sale price. Thus the networked commerce system (e.g., networked commerce system 102 in FIG. 1) can validate the risk profile and price the guarantee to sellers as an add-on benefit for selling on the networked commerce system (e.g., networked commerce system 102 in FIG. 1).

In some embodiments, the networked commerce system (e.g., the networked commerce system 102 in FIG. 1) selects (514) a predicted minimum sale price by discounting the average final sale price. The networked commerce system (e.g., the networked commerce system 102 in FIG. 1) then detects (516) a sale of the respective product in the respective auction transaction.

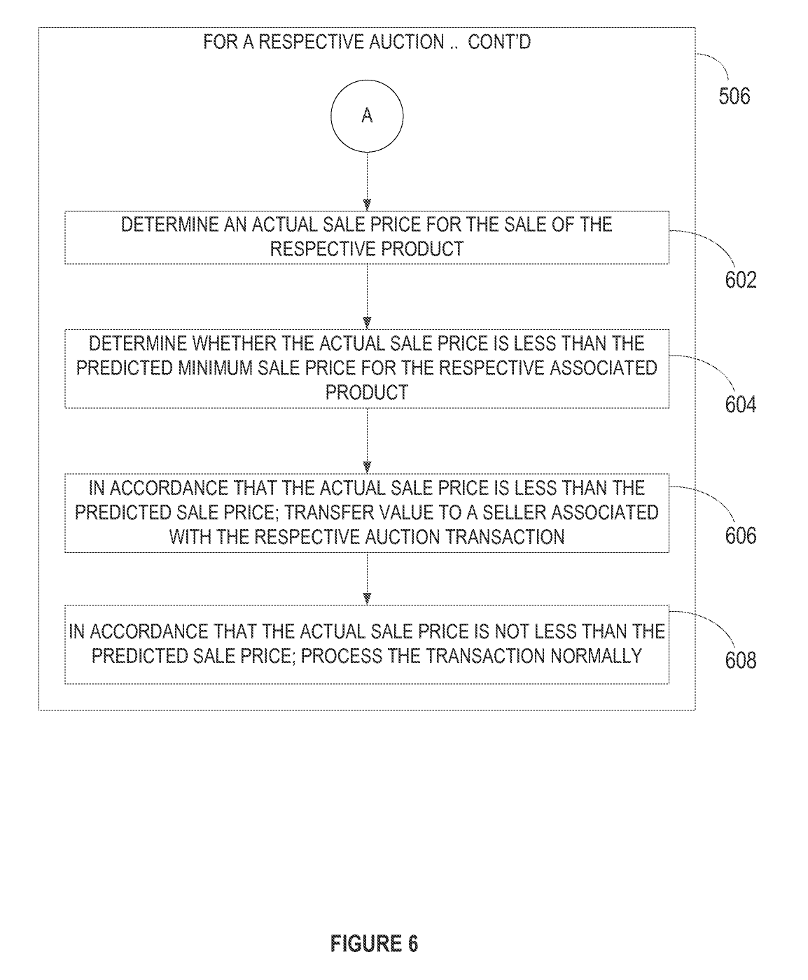

FIG. 6 is a flow diagram illustrating a process for preserving seller value through hidden reserve prices, in accordance with some embodiments. In some example embodiments, FIG. 6 is a continuation of the process in FIG. 5. Each of the operations shown in FIG. 6 may correspond to instructions stored in a computer memory or a computer readable storage medium, Optional operations are indicated by dashed lines (e.g., boxes with dashed-line borders). In some embodiments, the method described in FIG. 6 is performed by the networked commerce system (e.g., the networked commerce system 102 in FIG. 1).

In some embodiments, the method is performed by a computer system including one or more processors and memory storing one or more programs for execution by the one or more processors.

The networked commerce system (e.g., the networked commerce system 102 in FIG. 1) determines (602) an actual sale price for the sale of the respective product. The actual sale price is the price of the product actually received from a buyer of the product.

In some embodiments, the networked commerce system (e.g., the networked commerce system 102 in FIG. 1) determines (604) whether the actual sale price is less than the predicted minimum sate price for the respective associated product. In accordance with a determination that the actual sate price is less than the predicted minimum sale price, the networked commerce system (e.g., the networked commerce system 102 in FIG. 1) transfers (606) value to a seller associated with the respective auction transaction. For example, if the actual price is $75 and the predicted minimum sate price is $100, the networked commerce system (e.g., the networked commerce system 102 in FIG. 1) transfers $25 to the seller. In other examples, the networked commerce system (e.g., the networked commerce system 102 in FIG. 1) transfers less that the difference between the values, or transfers the value in credit.

In accordance with a determination that the actual sale price is not less than the predicted minimum sate price, the networked commerce system (e.g., the networked commerce system 102 in FIG. 1) processes (608) the transaction normally. For example, if the final price is $125 and the minimum sale price is $100, the networked commerce system (e.g., the networked commerce system 102 in FIG. 1) executes the transaction without any additional value transfer.

In some embodiments, identifying one or more similar sales transactions includes using one or more factors to determine similarity. For example, the one or more factors include one or more of the type of product, product fair market value, date and time of auction, country of origin of the product or the seller, product brand, time elapsed since the transaction was completed, and buy it now price. In some embodiments, each auction transaction has an associated seller and one or more associated bidders.

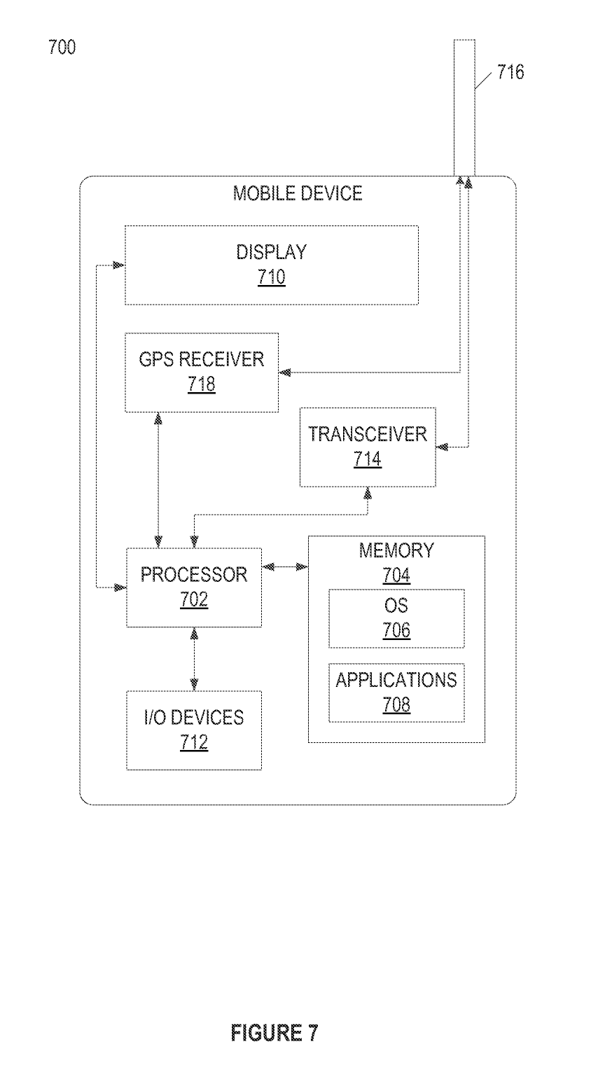

FIG. 7 is a block diagram illustrating a mobile device 700, according to an example embodiment. The mobile device 700 may include a processor 702. The processor 702 may be any of a variety of different types of commercially available processors suitable for mobile devices (for example, an XScale architecture microprocessor, a Microprocessor without Interlocked Pipeline Stages (MIPS) architecture processor, or another type of processor). A memory 704, such as a random access memory (RAM), a flash memory, or another type of memory, is typically accessible to the processor 702. The memory 704 may be adapted to store an operating system (OS) 706, as well as application programs 708, such as a mobile location enabled application that may provide Location Based Services (LBSs) to a user. The processor 702 may be coupled, either directly or via appropriate intermediary hardware, to a display 710 and to one or more input/output (I/O) devices 712, such as a keypad, a touch panel sensor, a microphone, and the like. Similarly, in some embodiments, the processor 702 may be coupled to a transceiver 714 that interfaces with an antenna 716. The transceiver 714 may be configured to both transmit and receive cellular network signals, wireless data signals, or other types of signals via the antenna 716, depending on the nature of the mobile device 700. Further, in sonic configurations, GPS receiver 718 may also make use of the antenna 716 to receive OPS signals.

### Software Architecture

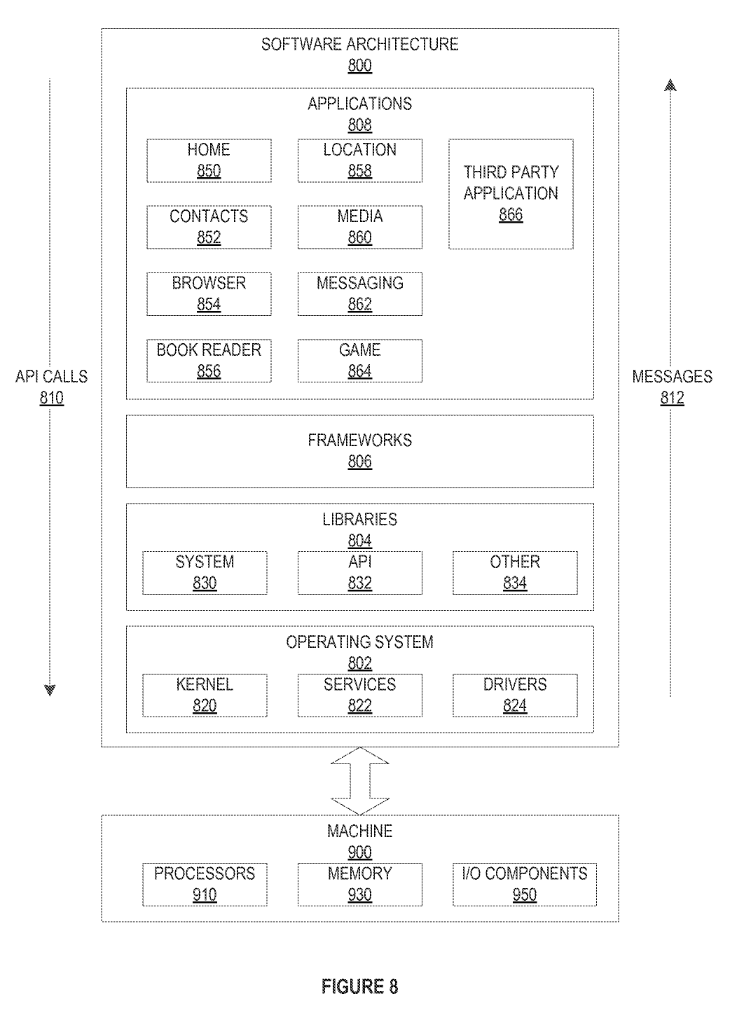

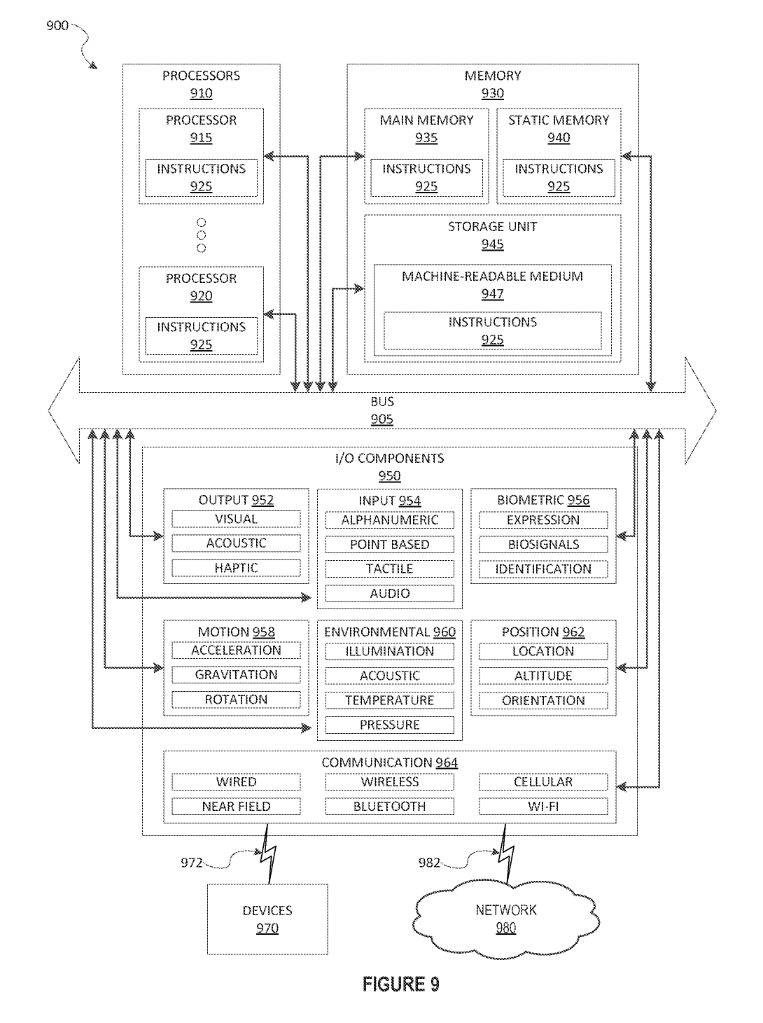

FIG. 8 is a block diagram illustrating an architecture of software 800, which may be installed on any one or more of the devices of FIG. 1 (e.g., client system(s) 110). FIG. 8 is merely a non-limiting example of a software architecture, and it will be appreciated that many other architectures may be implemented to facilitate the functionality described herein. The software 800 may be executing on hardware such as a machine 900 of FIG. 9 that includes processors 910, memory 930, and I/O components 950. In the example architecture of FIG. 8, the software 800 may be conceptualized as a stack of layers where each layer may provide particular functionality. For example, the software 800 may include layers such as an operating system 802, libraries 804, frameworks 806, and applications 808. Operationally, the applications 808 may invoke API calls 810 through the software stack and receive messages 812 in response to the API calls 810.

The operating system 802 may manage hardware resources and provide common services. The operating system 802 may include, for example, a kernel 820, services 822, and drivers 824. The kernel 820 may act as an abstraction layer between the hardware and the other software layers. For example, the kernel 820 may be responsible for memory management, processor management (e.g., scheduling), component management, networking, security settings, and so on. The services 822 may provide other common services for the other software layers. The drivers 824 may be responsible for controlling and/or interfacing with the underlying hardware. For instance, the drivers 824 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

The libraries 804 may provide a low-level common infrastructure that may be utilized by the applications 808. The libraries 804 may include system libraries 830 (e.g., C standard library) that may provide functions such as memory allocation functions, string manipulation functions, mathematic functions, and the like. In addition, the libraries 804 may include API libraries 832 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D in a graphic context on a display), database libraries (e.g., SQLite that may provide various relational database functions), web libraries (e.g., WebKit that may provide web browsing functionality), and the like. The libraries 804 may also include a wide variety of other libraries 834 to provide many other APIs to the applications 808.

The frameworks 806 may provide a high-level common infrastructure that may be utilized by the applications 808. For example, the frameworks 806 may provide various graphical user interface (GUI) functions, high-level resource management, high-level location services, and so forth. The frameworks 806 may provide a broad spectrum of other APIs that may be utilized by the applications 808, some of which may be specific to a particular operating system or platform.

The applications 808 include a home application 850, a contacts application 852, a browser application 854, a book reader application 856, a location application 858, a media application 860, a messaging application 862, a game application 864, and a broad assortment of other applications such as a third party application 866. in a specific example, the third party application 866 (e.g., an application developed using the Android™ or iOS™ software development kit (SDK) by an entity other than the vendor of the particular platform) may be mobile software running on a mobile operating system such as iOS™, Android, Windows® Phone, or other mobile operating systems. In this example, the third party application 866 may invoke the API calls 810 provided by the operating system 802 to facilitate functionality described herein.

### Example Machine Architecture and Machine-Readable Medium

FIG. 9 is a block diagram illustrating components of a machine 900, according to some example embodiments, able to read instructions from a machine-readable medium (e.g., a machine-readable storage medium) and perform any one or more of the methodologies discussed herein. Specifically, FIG. 9 shows a diagrammatic representation of the machine 900 in the example form of a computer system, within which instructions 925 (e.g., software, a program, an application, an applet, app, or other executable code) for causing the machine 900 to perform any one or more of the methodologies discussed herein may be executed. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but be not limited to, a server computer, a client computer, a PC, a tablet computer, a laptop computer, a netbook, a set-top box (STB), a personal digital assistant (FDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 925, sequentially or otherwise, that specify actions to be taken by the machine 900. Further, while only a single machine 900 is illustrated, the term “machine” shall also be taken to include a collection of machines 900 that individually or jointly execute the instructions 925 to perform any one or more of the methodologies discussed herein.

The machine 900 may include processors 910, memory 930, and I/O components 950, which may be configured to communicate with each other via a bus 905. In an example embodiment, the processors 910 (e.g., a CPU, a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (MC), another processor, or any suitable combination thereof) may include, for example, a processor 915 and a processor 920, which may execute the instructions 925. The term “processor” is intended to include multi-core processor that may comprise two or more independent processors (also referred to as “cores”) that may execute instructions contemporaneously. Although FIG. 9 shows multiple processors, the machine 900 may include a single processor with a single core, a single processor with multiple cores (e.g., a multi-core process), multiple processors with a single core, multiple processors with multiples cores, or any combination thereof.

The memory 930 may include a main memory 935, a static memory 940, and a storage unit 945 accessible to the processors 910 via the bus 905. The storage unit 945 may include a machine-readable medium 947 on which are stored the instructions 925 embodying any one or more of the methodologies or functions described herein. The instructions 925 may also reside, completely or at least partially, within the main memory 935, within the static memory 940, within at least one of the processors 910 (e.g., within the processor's cache memory), or any suitable combination thereof, during execution thereof by the machine 900. Accordingly, the main memory 935, the static memory 940, and the processors 910 may be considered machine-readable media 947.

As used herein, the term “memory” refers to a machine-readable medium 947 able to store data temporarily or permanently and may be taken to include, but not be limited to, RAM, read-only memory (ROM), buffer memory, flash memory, and cache memory. While the machine-readable medium 947 is shown in an example embodiment to be a single medium, the term “machine-readable medium” should be taken to include a single medium or multiple media (e.g., a centralized or distributed database, or associated caches and servers) able to store the instructions 925. The term “machine-readable medium” shall also be taken to include any medium, or combination of multiple media, that is capable of storing instructions (e.g., instructions 925) for execution by a machine (e.g., machine 900), such that the instructions, when executed by one or more processors of the machine (e.g., processors 910), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., Erasable Programmable Read-Only Memory (EPROM)), or any suitable combination thereof. The term “machine-readable medium” specifically excludes non-statutory signals per se.

The I/O components 950 may include a wide variety of components to receive input, provide and/or produce output, transmit information, exchange information, capture measurements, and so on. It will be appreciated that the I/O components 950 may include many other components that are not shown in FIG. 9. In various example embodiments, the I/O components 950 may include output components 952 and/or input components 954. The output components 952 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 954 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, and/or another pointing instrument), tactile input components (e.g., a physical button, a touch screen that provides location and force of touches or touch gestures, and/or other tactile input components), audio input components (e.g., a microphone), and the like.

In further example embodiments, the I/O components 950 may include biometric components 956, motion components 958, environmental components 960, and/or position components 962, among a wide array of other components. For example, the biometric components 956 may include components to detect expressions e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 958 may include acceleration sensor components (e.g., accelerometer), gravitation sensor components, rotation sensor components (e.g., gyroscope), and so forth. The environmental components 960 may include, for example, illumination sensor components (e.g., photometer), acoustic sensor components (e.g., one or more microphones that detect background noise), temperature sensor components (e.g., one or more thermometers that detect ambient temperature), humidity sensor components, pressure sensor components (e.g., barometer), proximity sensor components (e.g., infrared sensors that detect nearby objects), and/or other components that may provide indications, measurements, and/or signals corresponding to a surrounding physical environment. The position components 962 may include location sensor components (e.g., a GPS receiver component), altitude sensor components (e.g., altimeters and/or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 and/or devices 970 via a coupling 982 and a coupling 972, respectively. For example, the communication components 964 may include a network interface component or another suitable device to interface with the network 980. In further examples, the communication components 964 may include wired communication components, wireless communication components, cellular communication components, Near Field Communication (NEC) components, Bluetooth® components (e.g., Bluetooth® Low Energy), Wi-Fi® components, and other communication components to provide communication via other modalities. The devices 970 may be another machine and/or any of a wide variety of peripheral devices (e.g., a peripheral device coupled via a USB).

Moreover, the communication components 964 may detect identifiers and/or include components operable to detect identifiers. For example, the communication components 964 may include Radio Frequency Identification (RFID) tag reader components, NFC smart tag detection components, optical reader components (e.g., an optical sensor to detect one-dimensional bar codes such as Universal Product Code (UPC) bar codes, multi-dimensional bar codes such as a Quick Response (QR) codes, Aztec code, Data Matrix, Dataglyph, MaxiCode, PDF48, Ultra Code, UCC RSS-2D bar codes, and other optical codes), acoustic detection components (e.g., microphones to identify tagged audio signals), and so on. In addition, a variety of information may be derived via the communication components 964, such as location via Internet Protocol (IP) geo-location, location via Wi-Fi® signal triangulation, location via detecting an NFC beacon signal that may indicate a particular location, and so forth.

### Transmission Medium

In various example embodiments, one or more portions of the network 980 may be an ad hoc network, an intranet, an extranet, a virtual private network (VPN), a LAN, a wireless LAN (WLAN), a WAN, a wireless WAN (WWAN), a MAN, the Internet, a portion of the Internet, a portion of the Public Switched Telephone Network (PSTN), plain old telephone service (POTS) network, a cellular telephone network, a wireless network, a Wi-Fi® network, another type of network, or a combination of two or more such networks. For example, the network 980 or a portion of the network 980 may include a wireless or cellular network, and the coupling 982 may be a Code Division Multiple Access (CDMA) connection, a Global System for Mobile communications (GSM) connection, or another type of cellular or wireless coupling. In this example, the coupling 982 may implement any of a variety of types of data transfer technology, such as Single Carrier Radio Transmission Technology (1xRIT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other tong range protocols, or other data transfer technology.

The instructions 925 may be transmitted and/or received over the network 980 using a transmission medium via a network interface device (e.g., a network interface component included in the communication components 964) and utilizing any one of a number of well-known transfer protocols (e.g., HyperText Transfer Protocol (HTTP)). Similarly, the instructions 925 may be transmitted and/or received using a transmission medium via the coupling 972 (e.g., a peer-to-peer coupling) to the devices 970. The term “transmission medium” shall be taken to include any intangible medium that is capable of storing, encoding, or carrying the instructions 925 for execution by the machine 900, and includes digital or analog communications signals or other intangible media to facilitate communication of such software.

Furthermore, the machine-readable medium 947 is non-transitory (in other words, not having any transitory signals) in that it does not embody a propagating signal. However, labeling the machine-readable medium 947 “non-transitory” should not be construed to mean that the medium is incapable of movement; the medium should be considered as being transportable from one physical location to another. Additionally, since the machine-readable medium 947 is tangible, the medium may be considered to be a machine-readable device.

### Term Usage

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The foregoing description, for purpose of explanation, has been presented with reference to specific implementations. However, the illustrative discussions above are not intended to be exhaustive or to limit the possible implementations to the precise forms disclosed. Many modifications and variations are possible in view of the above teachings. The implementations were chosen and described in order to best explain the principles involved and their practical applications, to thereby enable others skilled in the art to best utilize the various implementations with various modifications as are suited to the particular use contemplated.

It will also be understood that, although the terms “first,” “second,” and so forth may be used herein to describe various elements, these elements should not be limited by these terms. These terms are only used to distinguish one element from another. For example, a first contact could be termed a second contact, and, similarly, a second contact could be termed a first contact, without departing from the scope of the present implementations. The first contact and the second contact are both contacts, but they are not the same contact.

The terminology used in the description of the implementations herein is for the purpose of describing particular implementations only and is not intended to be limiting. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if (a stated condition or event) is detected” may be construed to mean “upon determining” or “in response to determining” or “upon detecting (the stated condition or event)” or “in response to detecting (the stated condition or event),” depending on the context.

What is claimed is:

1. A method comprising:
storing historical transaction data for a plurality of transactions;
operating a networked commerce system, wherein a plurality of auction transactions are performed through the networked commerce system; and
for a respective auction transaction of the plurality of auction transactions on the networked commerce system, wherein the respective auction transaction has a respective associated product:
determining, using one or more processors in the networked commerce system, a predicted minimum sale price for the respective associated product, wherein the determining is based on the stored historical transaction data;
detecting a sale of the respective associated product in the respective auction transaction;
determining an actual sale price for the sale of the respective associated product;
determining whether the actual sale price is less than the predicted minimum sale price for the respective associated product; and
in accordance with a determination that the actual sale price is less than the predicted minimum sale price, transferring value to a seller associated with the respective auction transaction.

2. The method of claim 1, further including:
in accordance with a determination that the actual sale price is not less than the predicted minimum sale price, processing the auction transaction normally.

3. The method of claim 1, wherein determining the predicted minimum sale price further includes:
identifying one or more similar auction transactions in the stored historical transaction data;
using a final sale price fir at least one of the identified similar auction transactions, determining an average final sale price; and
selecting the predicted minimum sale price by discounting the average final sale price.

4. The method of claim 3, wherein identifying the one or more similar auction transactions includes using one or more factors to determine similarity.

5. The method of claim 4, wherein the one or more factors include one or more of a type of product, a product fair market value, a date and time of auction, a country of origin, a product brand, a time elapsed since the auction transaction was completed, and a buy it now price.

6. The method of claim 1, wherein each auction transaction has an associated seller and one or more associated bidders.

7. The method of claim 1, wherein the transferred value is the difference between the actual sale price and the predicted minimum sale price.

8. A system comprising:
one or more processors configured to include:
a storage module for storing historical transaction data for a plurality of transactions;
an operation module for operating a networked commerce system presenting a media content item on an electronic display; and
for a respective product associated with a respective auction transaction on the networked commerce system:
a determination module for determining, based on the stored historical transaction data, a predicted minimum sale price for the respective associated product;
a detection module for detecting a sale of le respective associated product in the respective auction transaction;
a sale price module for determining an actual sale price for the sale of the respective associated product;
a comparison module for determining whether the actual sale price is less than the predicted minimum sale price for the respective associated product; and
a transferring module for, with a determination that the actual sale price is less than the predicted minimum sale price, transferring value to a seller associated with the respective auction transaction.

9. The system of claim 8, further including:
a processing module for, in accordance with a determination that the actual sale price is not less than the predicted minimum sale price, processing the auction transaction normally.

10. The system of claim 8, wherein the determination module for determining the predicted minimum sale price further includes:
an identification module for identifying one or more similar auction transactions in the stored historical transaction data;
a final price module for using a final sale price for at least one of the identified similar auction transactions to deter nine an average final sale price; and
a minimum sale price module for selecting the predicted minimum sale price by discounting the average final sale price.

11. The system of claim 10, wherein identifying the one or more similar auction transactions includes using one or more factors to determine similarity.

12. The system of claim 11, wherein the one or more factors include one or more of a type of product, a product fair market value, a date and time of auction, a country of origin, a product brand, a time elapsed since the auction transaction was completed, and a buy it now price.

13. The system of claim 8, wherein the auction transaction has an associated seller and one or more associated bidders.

14. The system of claim 8, wherein the transferred value is the difference between the actual sale price and the predicted minimum sale price.

15. A non-transitory computer readable storage medium storing one or more programs for execution by one or more processors, the one or more programs comprising instructions for:
storing historical transaction data for a plurality of transactions;
operating a networked commerce system presenting a media content item on an electronic display; and
for a respective auction transaction on the networked commerce system, wherein the respective auction transaction has a respective associated product:
determining, based on the stored historical transaction data, a predicted minimum sale price for the respective associated product;
detecting a sale of the associated respective product in the respective auction transaction;
determining an actual sale price for the sale of the respective associated product;
determining whether the actual sale price is less than the predicted minimum sale price for the respective associated product; and
in accordance with a determination that the actual sale price is less than the predicted minimum sale price, transferring value to a seller associated with the respective auction transaction.

16. The non-transitory computer readable storage medium of claim 15, further including:
in accordance with a determination that the actual sale price is not less than the predicted minimum sale price, processing the auction. transaction normally.

17. The non-transitory computer readable storage medium of claim 15, wherein determining the predicted minimum sale price further includes:
identifying one or more similar auction transactions in the stored historical transaction data;
using a final sale price for at least one of the identified similar auction transactions, determining an average final sale price; and
selecting the predicted minimum sale price by discounting the average final sale price.

18. The non-transitory computer readable storage medium of claim 17, wherein identifying the one or more similar auction transactions includes using one or more factors to determine similarity.

19. The non-transitory computer readable storage medium of claim 18, wherein the one or more factors include one or more of a type of product, a product fair market value, a date and time of auction, a country of origin, a product brand, a time elapsed since the auction transaction was completed, and a buy it now price.

20. The non-transitory computer readable storage medium of claim 15, wherein the auction transaction has an associated seller and one or more associated bidders.
